(19) United States
(12) Patent Application Publication
(10) Pub. No.: US 2009/0251741 A1
(43) Pub. Date: Oct. 8, 2009

(54) SCANNER WITH LED LIGHT SOURCE

(75) Inventors: Thomas Sheng, Hsinchu (TW); Chih-Yi Wang, Chiayi County (TW); Tsung-Ying Tsou, Taipei County (TW)

Correspondence Address: COVENANT IP CONSULTING CO., P.O. BOX 34-306 TAIPEI CITY, TAIPEI, 10499, TW

(73) Assignee: AVISION INC., Hsinchu (TW)

(21) Appl. No.: 12/416,143

(22) Filed: Mar. 31, 2009

(30) Foreign Application Priority Data
Apr. 2, 2008 (TW) 97112056

(51) Int. Cl. H04N 1/04

(52) U.S. Cl. 358/475

(57) ABSTRACT

A scan module and a scanner using the same are provided. The scanner includes a housing and a scan module. The housing has a scan platform for supporting a to-be-scanned document. The scan module disposed inside the housing includes a light emitting diode (LED) light source, a reflector and an optical module. The LED light source for emitting a light beam is directed towards the reflector. The reflector is for reflecting the light beam, and the light beam reflected by the reflector is projected on the to-be-scanned document. The optical module is for receiving the light beam reflected from the to-be-scanned document placed on the scan platform. The light beam emitted by the LED light source is reflected by the reflector at least once before arriving at the to-be-scanned document.

This application claims the benefit of Taiwan application Serial No. 97112056, filed Apr. 2, 2008, the subject matter of which is incorporated herein by reference.

### BACKGROUND OF THE INVENTION

1. Field of the Invention

The invention relates in general to a scan module and a scanner using the same, and more particularly to a scan module using an LED array as the light source and a scanner using the same.

2. Description of the Related Art

Nowadays, scanners are widely used in home and offices. A scanner scans the contents or images of a paper document for the user and stores and displays the scanned contents or images in form of electronic files to facilitate the transmission of documents and the processing of images.

Take a flatbed scanner as an example. To perform document scanning, a to-be-scanned document is first placed on a transparent scan platform. Next, a light beam provided by a scan module of the scanner is projected on the to-be-scanned document. Then, an optical module receives the light beam reflected from the to-be-scanned document. To reduce the power consumption of the scanner and increase the optical efficiency of the light source, recently, scanners using LED arrays instead of cold cathode fluorescent lamps (CCFLs) as light sources are provided. In the scanner using an LED array as the light source, several LEDs are disposed on a circuit board for emitting a light beam and projecting the light beam on the to-be-scanned document.

Referring to FIG. 1, a side view of a conventional scan module using LEDs as the light source is shown. The scan module 130 is disposed under a scan platform 111, and the scan module 130 includes an LED light source 131, a holder 134 and an optical module 133. The LED light source 131 disposed on the holder 134 includes several LEDs for emitting a light beam E and projecting the light beam E on a to-be-scanned document P placed on the scan platform 111. As the LED is a point light source, for the light beam to be uniformly projected on the to-be-scanned document P, a distance for light uniformization between the LED light source 131 and the to-be-scanned document P is required for the light beam E emitted by the LEDs to be adequately uniformized. However, according to the way of projecting the light beam E shown in FIG. 1, because the length of the optical path of the light beam E must be long enough for uniformizing the light beam E, the vertical distance between the scan module 130 and the to-be-scanned document P is largely increased. As a result, the overall height of the scanner can not be reduced effectively, and the trend of miniaturization of electronic products is violated. Besides, uniformizing the light beam E merely by increasing the distance for light uniformization still cannot make the to-be-scanned document P be illuminated uniformly, hence degrading the quality of the scanned image.

### SUMMARY OF THE INVENTION

The invention is directed to a scan module and a scanner using the same. The light beam emitted by the scan module is reflected at least once before arriving at the to-be-scanned document. Under the condition that the length of the optical path remains the same, the vertical distance between the light source and the to-be-scanned document is reduced, so as to further reduce the height and the volume of the scanner.

According to a first aspect of the present invention, a scan module, including a light emitting diode (LED) light source, a reflector and an optical module is provided. The LED light source for emitting a light beam is directed towards the reflector. The reflector is for reflecting the light beam, and the light beam reflected by the reflector is projected on a to-be-scanned document. The optical module is for receiving the light beam reflected from the to-be-scanned document. The light beam emitted by the LED light source is reflected by the reflector at least once before arriving at the to-be-scanned document.

According to a second aspect of the present invention, a scanner including a housing and a scan module is provided. The housing has a scan platform for supporting a to-be-scanned document. The scan module disposed inside the housing includes a light emitting diode (LED) light source, a reflector and an optical module. The LED light source for emitting a light beam is directed towards the reflector. The reflector is for reflecting the light beam, and the light beam reflected by the reflector is projected on the to-be-scanned document. The optical module is for receiving the light beam reflected from the to-be-scanned document placed on the scan platform. The light beam emitted by the LED light source is reflected by the reflector at least once before arriving at the to-be-scanned document.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a fragmented side view of a conventional scanner using LEDs as the light source;

FIG. 2 shows a scanner according to a first embodiment of the invention;

FIG. 3A shows an exploded diagram of the reflector and the LED light source shown in FIG. 2 and also shows an implementation of a light homogenizer;

FIG. 3B shows another implementation of the light homogenizer shown in FIG. 3A;

FIG. 3C shows yet another implementation of the light homogenizer shown in FIG. 3A;

FIG. 4 shows a scan module with a spacer;

FIG. 5 shows a scan module according to a second embodiment of the invention;

FIG. 6 shows a scan module similar to that shown in FIG. 5 but with a reflector with one concave reflecting surface; and

FIG. 7 shows a scan module similar to that shown in FIG. 5 but with a reflector with two concave reflecting surfaces.

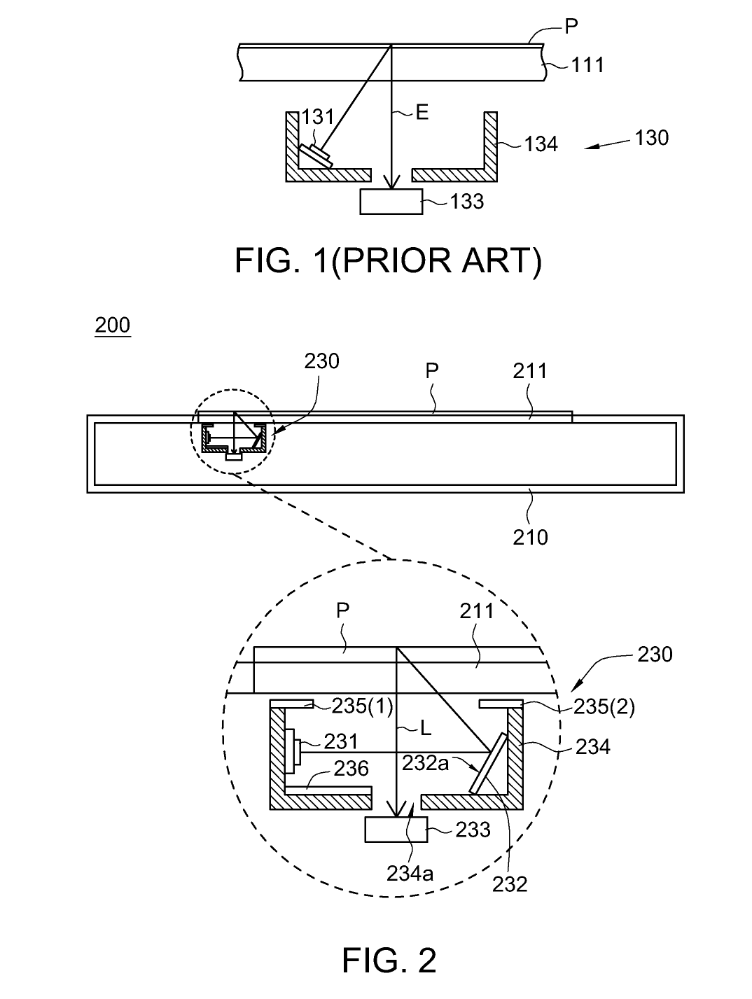

### DETAILED DESCRIPTION OF THE INVENTION

According to the invention, the scan module of the scanner mainly includes a light emitting diode (LED) light source, a reflector and an optical module. The LED light source is directed towards the reflector for emitting a light beam and projecting the light beam towards the reflector. The light beam is reflected by the reflector at least once before arriving at a to-be-scanned document. While the optical path length of the light beam in the scanner of the invention is the same with that in a conventional scanner, the vertical distance between the LED light source and the to-be-scanned document in the scanner of the invention is reduced so as to further reduce the height of the scanner. The details of the invention are disclosed below in a first and a second embodiments. The difference between the two embodiments mainly lies in the disposition of the LED light source and the reflector. However, the two embodiments are used for elaboration only not for limiting the scope of protection of the invention. Besides, unconcerned elements are omitted in the embodiments for highlighting the technical features of the invention.

### First Embodiment

Referring to FIG. 2, a scanner according to a first embodiment of the invention is shown. The scanner 200 includes a housing 210 and a scan module 230. The housing 210 has a scan platform 211 for supporting a to-be-scanned document P. The scan module 230 disposed inside the housing 210 mainly includes a light emitting diode (LED) light source 231, a reflector 232 and an optical module 233. The LED light source 231 for emitting a light beam L is directed towards the reflector 232. The reflector 232 is for reflecting the light beam L, and the light beam L reflected by the reflector 232 is projected on the to-be-scanned document P. As indicated in FIG. 2, the light beam L is reflected by the reflector 232 once before arriving at the to-be-scanned document P. Moreover, the optical module 233 is for receiving the light beam L reflected by the to-be-scanned document P. The optical module 233 can include, for example, reflective mirrors, lenses and image sensors.

The scan module 230 further includes a holder 234 as indicated in FIG. 2. The LED light source 231 and the reflector 232 are disposed on the holder 234. The to-be-scanned document P is positioned above the holder 234. The holder 234 has an opening 234a through which the optical module 233 receives the light beam L reflected from the to-be-scanned document P. The LED light source 231 and the reflector 232 are opposite to each other and disposed at the two opposite sides of the opening 234a. The optical path of the light beam L is described as follow. First, the light beam L emitted by the LED light source 231 travels to the reflector 232 in a direction parallel to the plane of the to-be-scanned document P placed on the scan platform 211. Next, the light beam L reflected by the reflector 232 once is projected on the to-be-scanned document P. Then, the light beam L reflected by the to-be-scanned document P is projected on the optical module 233 through the opening 234a. Compared with the light source of a conventional scan module which emits a light beam and projects the light beam directly on the to-be-scanned document, the LED light source 231 of the present embodiment of the invention emits the light beam L in a direction parallel to the to-be-scanned document P, such that the vertical distance between the LED light source 231 and the to-be-scanned document P is reduced, and the height of the scanner 200 is thus reduced. Moreover, as the light beam L is projected on the to-be-scanned document P by way of reflection, in the scanner 200 having a smaller height than the conventional scanner, the length of the optical path of the light beam L from the LED light source 231 to the image sensor inside the optical module 233 can remain unchanged.

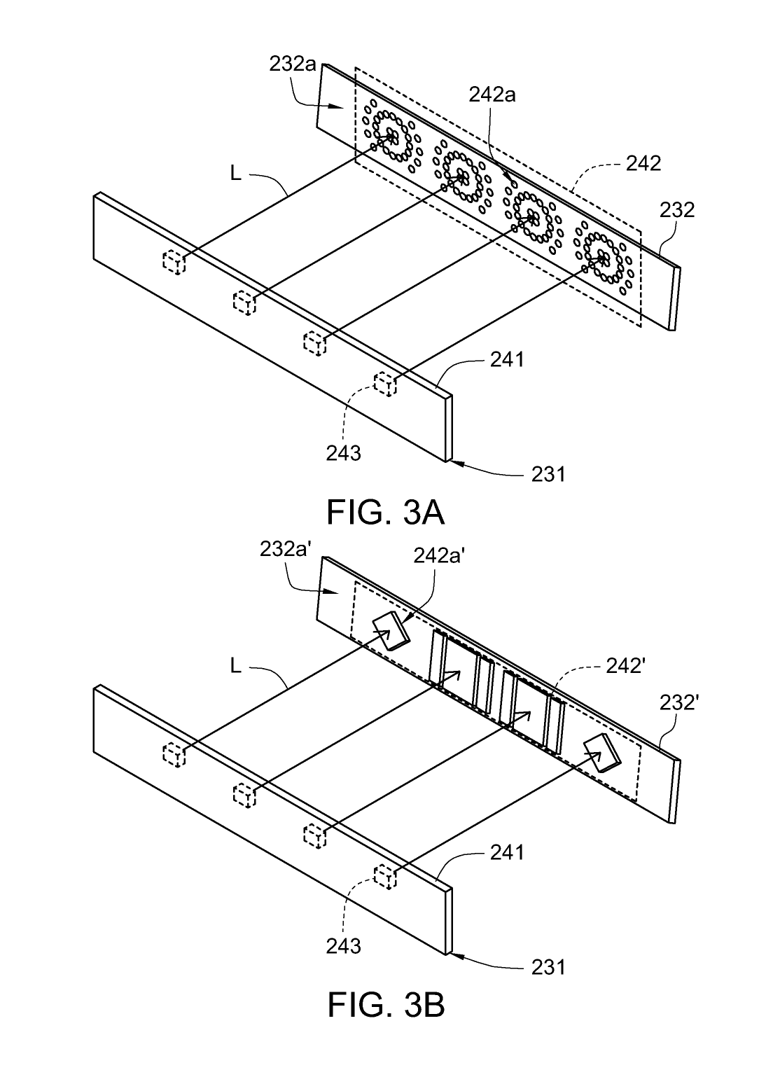

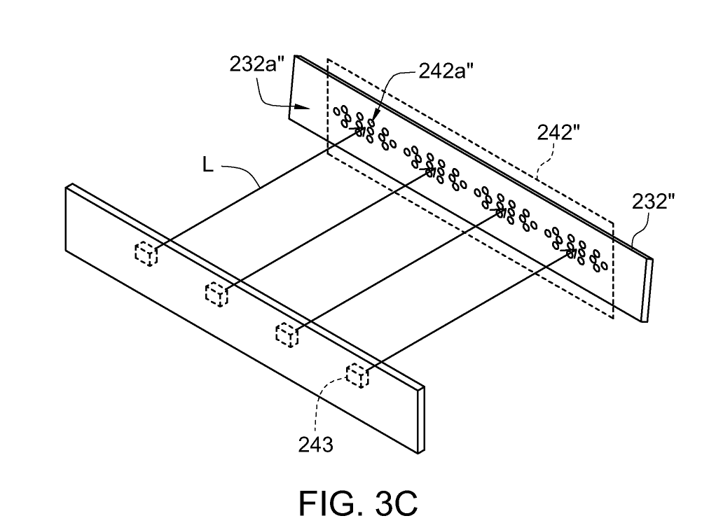

Referring to FIG. 3A, an exploded diagram of the reflector and the LED light source shown in FIG. 2 is shown and an implementation of a light homogenizer is also shown. In the present embodiment of the invention, the reflector 232 has a reflecting surface 232a and a light homogenizer 242 for uniformizing the light beam L. The light homogenizer 242 is formed on the reflecting surface 232a, which is directed towards the LED light source 231. The LED light source 231, for example, includes a bar-shaped circuit board 241 and several LEDs 243 disposed on the bar-shaped circuit board 241 in an array. In the present embodiment of the invention, the light homogenizer 242 may include a non-reflective or a low-reflective structure. For example, the light homogenizer 242 includes several low-reflective dots 242a. A distribution density of the low-reflective dots 242a is higher in areas of the reflecting surface 232a corresponding to positions of the LEDs 243 than in other areas of the reflecting surface 232a. Thus, the light beam L emitted by the discrete LEDs 243 is uniformized, the to-be-scanned document P is illuminated by a uniformized light beam L, and the quality of the scanned image is improved. Referring to FIG. 3B, another implementation of the light homogenizer alternate to that shown in FIG. 3A is shown. The light homogenizer 242′ includes at least one protrusion 242a′ disposed on the reflecting surface 232a′ and positioned at locations corresponding to positions of the LEDs 243. The protrusion 242a′ is for absorbing the light beam L. Also, there is no further restriction regarding the shape and the number of the protrusion 242a′ in the present embodiment of the invention, and any design of the protrusion 242a′ capable of uniformizing the light beam L can be used here. Referring to FIG. 3C, yet another implementation of the light homogenizer alternate to that shown in FIG. 3A is shown. The light homogenizer 242″ includes several reflective bumps 242a″. A distribution density of the reflective bumps 242a″ is higher in areas of the reflecting surface 232a″ corresponding to positions of the LEDs 243 than in other areas of the reflecting surface 232a″, such that the light beam L is scattered to where the luminance is weaker from where the luminance is stronger so as to achieve uniform luminance of the light beam. However, anyone who is skilled in the technology of the invention will understand that the design of the light homogenizer 242 is not limited thereto.

Also, the scan module 230 of the present embodiment of the invention includes a first light absorber 235(1), a second light absorber 235(2) and an auxiliary light reflector 236 in addition to the LED light source 231, the reflector 232, the optical module 233 and the holder 234 disclosed above. The first light absorber 235(1), the second light absorber 235(2) and the auxiliary light reflector 236, for example, can be plate-shaped. The first light absorber 235(1) and the second light absorber 235(2) are disposed on the holder 234. The first light absorber 235(1) is positioned above the LED light source 231, and the second light absorber 235(2) is positioned above the reflector 232 as indicated in FIG. 2. The first light absorber 235(1) and the second light absorber 235(2) preferably are made by a black material for absorbing and blocking the scattered light beam generated after the light beam L is reflected, lest the scattered light beam might degrade the image quality. In other embodiments, the scan module 230 may include only one of the first light absorber 235(1) and the second light absorber 235(2).

The auxiliary light reflector 236 is disposed on the holder 234 and positioned beside the LED light source 231 as indicated in FIG. 2. One reflecting surface of the auxiliary light reflector 236 is directed towards the LED light source 231 and is used for reflecting a part of the light beam L to focus the light beam L, such that the light beam L emitted from the LED light source 231 can be more effectively projected on the to-be-scanned document P. In the present embodiment of the invention, the auxiliary light reflector 236 is disposed on a bottom surface of the holder 234. However, the position of the auxiliary light reflector 236 is not limited thereto, and any design capable of reflecting a part of the light beam L not projected on the reflector 232 (that is, the part of the light beam L cannot be reflected towards the to-be-scanned document P by the reflector 232) towards the reflector 232 can be used in the present embodiment of the invention.

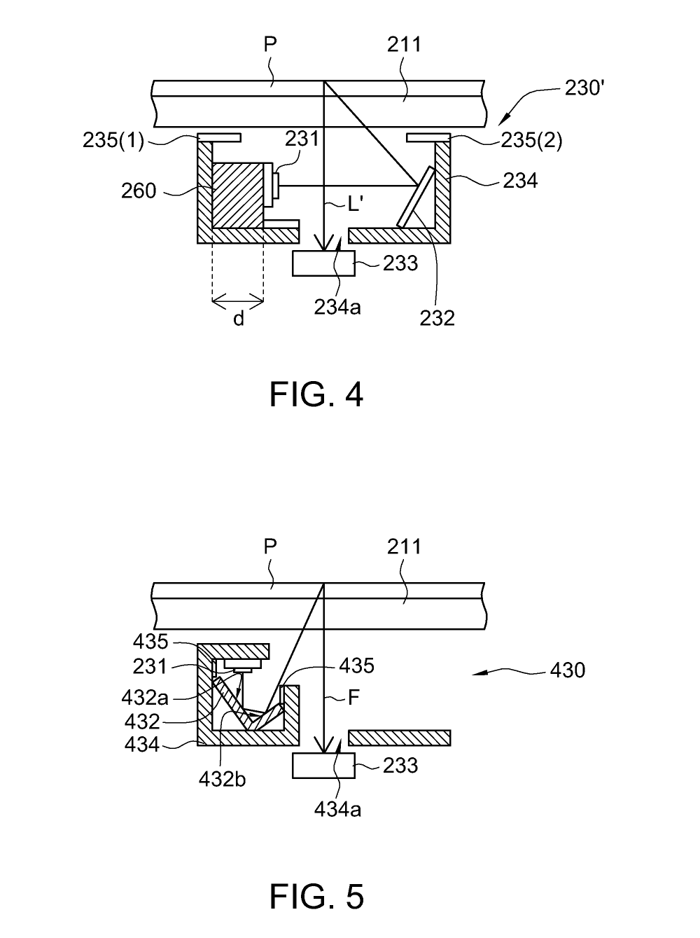

In the scanner 200 of the present embodiment of the invention, the scan module 230 may further include a spacer. Referring to FIG. 4, a scan module with a spacer is shown. The scan module 230′ includes a spacer 260 disposed between the LED light source 231 and the holder 234. The distance d between the LED light source 231 and the holder 234 can be adjusted by changing the thickness of the spacer 260 so as to change the length of the optical path of the light beam L′ between the LED light source 231 and the reflector 232 to fit the needs of different products.

In the scanner 200 using the scan module 230 of the first embodiment of the invention, a light beam L is emitted and travels in a direction parallel to the plane of the to-be-scanned document P, and the light beam L is further reflected towards the to-be-scanned document P by the reflector 232. Under the condition that the length of the optical path remains unchanged, the vertical distance between the LED light source 231 and the to-be-scanned document P is reduced, and the height of the scanner 200 is also reduced. Besides, by disposing a first light absorber 235(1) and a second light absorber 235(2) and an auxiliary light reflector 236 on the holder 234, both the utilization efficiency of the light beam L emitted by the LED light source 231 and the image quality are improved. In the present embodiment of the invention, the scan module 230 includes an LED light source 231, a reflector 232, an optical module 233, a holder 234, a first light absorber 235(1), a second light absorber 235(2), an auxiliary light reflector 236 and a spacer 260. However, anyone who is skilled in the technology of the invention will understand that the scan module 230 of the present embodiment of the invention can further include other elements.

### Second Embodiment

The scan module of the present embodiment of the invention differs from the scan module 230 of the first embodiment of the invention mainly in the disposition relationship between the LED light source and the reflector and in the design of the reflector, and the other similarities are not repeated here. The same designations are used for the elements of the present embodiment of the invention similar to that of the scan module of the first embodiment.

Referring to FIG. 5, a scan module according to the second embodiment of the invention is shown. The LED light source 231 and the reflector 432 are disposed on the holder 434. In the present embodiment of the invention, the reflector 432 is disposed under the LED light source 231, and the light beam F emitted from the LED light source 231 travels to the reflector 432 in a direction perpendicular to the plane of the to-be-scanned document P placed on the scan platform. The reflector 432 has a first reflecting surface 432a and a second reflecting surface 432b. The first reflecting surface 432a is adjacent to the second reflecting surface 432b. The light beam F emitted from the LED light source 231 is reflected sequentially by the first reflecting surface 432a and the second reflecting surface 432b, and then the reflected light beam F is projected on the to-be-scanned document P as indicated in FIG. 5. In the scan module 430 of the present embodiment of the invention, the light beam F is reflected twice by the reflector 432, and consequently the length of the optical path from the LED light source 231 to the optical module 233 is elongated and the vertical distance between the scan module 430 and the to-be-scanned document P can be reduced. As a result, the height of the scanner (not illustrated in FIG. 5) using the scan module 430 can be reduced.

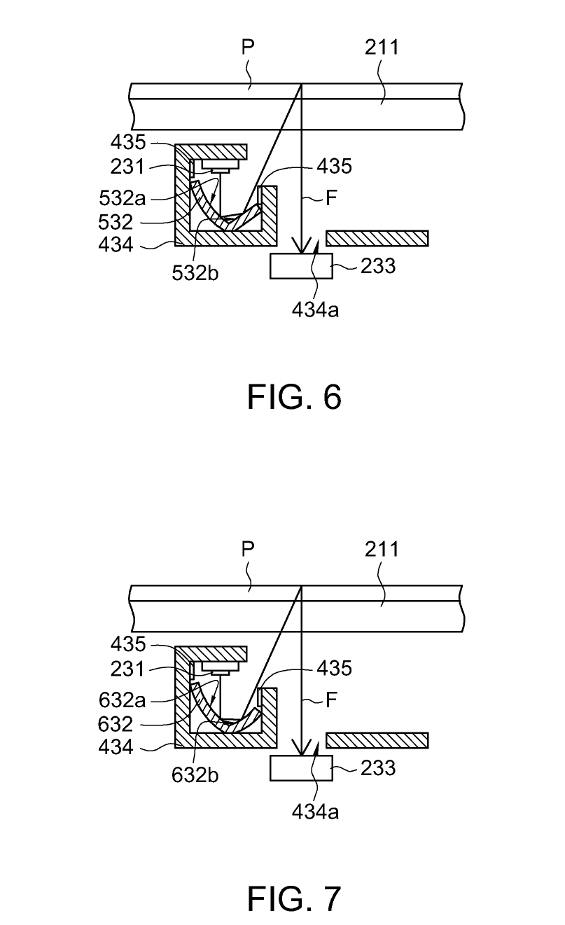

In the scan module 430 as shown in FIG. 5, the first reflecting surface 432a and the second reflecting surface 432b of the reflector 432 are respectively exemplified by a planar reflecting surface. However, in other implementations, the first reflecting surface 432a and the second reflecting surface 432b can be concave reflecting surfaces. Referring to FIG. 6, a reflector 532 with one concave reflecting surface is shown. The first reflecting surface 532a of the reflector 532 is a concave reflecting surface, and the second reflecting surface 532b of the reflector 532 is a planar reflecting surface. Referring to FIG. 7, a reflector 632 with two concave reflecting surfaces is shown. The first reflecting surface 632a and the second reflecting surface 632b of the reflector 632 both are concave reflecting surfaces. The reflector 532 and 632 focus the light beam F emitted by the LED light source 231 comprising a plurality of point light sources at the to-be-scanned document P by using at least one concave reflecting surface, so as to concentrate the light beam F on a confined area on the to-be-scanned document P, increase the uniformity of the light beam F projected on the to-be-scanned document P, and further increase optical efficiency.

Besides, the scan module 430 of the present embodiment of the invention, for example, includes at least one plate-shaped light absorber 435 disposed on the holder 434 and positioned beside the LED light source 231 or the reflectors 432, 532 or 632. The light absorber 435 preferably is a black material for absorbing and blocking the scattered light beam generated after the light beam F is reflected, lest the scattered light beam might interfere with the receiving of the light beam F reflected from the to-be-scanned document P by the optical module 233, hence improving the image quality.

In the present embodiment of the invention, the reflector 432 has a first reflecting surface 432a and a second reflecting surface 432b. However, the technology of the invention is not limited thereto. The reflector 432 can have more than two reflecting surfaces being a planar reflecting surface or a concave reflecting surface respectively for reflecting the light beam F more than twice before the light beam F arrives at the to-be-scanned document P, further increasing the length of the optical path. Besides, each reflecting surface of the reflector 432 can have a light homogenizer formed thereon for uniformizing the light beam F, so as to increase the uniformity of the light beam F projected on the to-be-scanned document P and improve image quality as a result.

According to the scan module and the scanner using the same disclosed in the first and the second embodiment of the invention, the light beam emitted by the LED light source is projected on the reflector first and then is reflected by the reflector at least once. Thus, the length of the optical path of the light beam remains unchanged, the vertical distance between the scan module and the to-be-scanned document is reduced, and the height of the scanner is thus reduced.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanner, comprising:
a housing, which comprises a scan platform for supporting a to-be-scanned document; and
a scan module, disposed inside the housing, wherein the scan module comprises:
a light emitting diode (LED) light source for emitting a light beam;
a reflector for reflecting the light beam emitted by the LED light source; and
an optical module for receiving the light beam;
wherein the light beam emitted by the LED light source is reflected by the reflector at least once before arriving at the to-be-scanned document placed on the scan platform;
wherein the optical module receives the light beam reflected from the to-be-scanned document placed on the scan platform.

2. The scanner according to claim 1, wherein the light beam emitted by the LED light source travels in a direction parallel to the plane of the scan platform.

3. The scanner according to claim 2, wherein the scan module further comprises a holder on which the LED light source and the reflector are disposed, the holder has an opening, the LED light source and the reflector are disposed at two opposite sides of the opening, and the light beam reflected from the to-be-scanned document is received by the optical module through the opening.

4. The scanner according to claim 3, wherein the scan module further comprises:
a first light absorber, which is plate-shaped and is disposed on the holder and positioned above the LED light source; and
a second light absorber, which is plate-shaped and is disposed on the holder and positioned above the reflector.

5. The scanner according to claim 3, wherein the scan module further comprises a plate-shaped auxiliary light reflector disposed on the holder and beside the LED light source, a reflecting surface of the auxiliary light reflector is directed towards the LED light source, and the auxiliary light reflector is for reflecting a part of the light beam.

6. The scanner according to claim 3, wherein the scan module further comprises:
a spacer disposed between the LED light source and the holder for adjusting the distance between the LED light source and the holder so as to change an optical path length of the light beam between the LED light source and the reflector.

7. The scanner according to claim 1, wherein the light beam emitted by the LED light source travels in a direction perpendicular to the plane of the scan platform.

8. The scanner according to claim 7, wherein the scan module further comprises a holder on which the LED light source and the reflector are disposed and the reflector is disposed under the LED light source.

9. The scanner according to claim 8, wherein the scan module further comprises:
at least one plate-shaped light absorber disposed on the holder and beside the LED light source or the reflector.

10. The scanner according to claim 7, wherein the reflector has a first reflecting surface and a second reflecting surface, the first reflecting surface is adjacent to the second reflecting surface, and the light beam emitted by the LED light source is reflected sequentially by the first reflecting surface and the second reflecting surface before arriving at the to-be-scanned document.

11. The scanner according to claim 10, wherein the first reflecting surface is selected from the group consisting of a planar reflecting surface and a concave reflecting surface.

12. The scanner according to claim 10, wherein the second reflecting surface is selected from the group consisting of a planar reflecting surface and a concave reflecting surface.

13. The scanner according to claim 10, wherein the first reflecting surface and the second reflecting surface both are concave reflecting surfaces.

14. The scanner according to claim 1, wherein the reflector has a light homogenizer for uniformizing the light beam and the light homogenizer is formed on a reflecting surface, which is directed towards the LED light source, of the reflector.

15. The scanner according to claim 14, wherein the light homogenizer comprises a plurality of low-reflective dots.

16. The scanner according to claim 15, wherein the LED light source comprises a bar-shaped circuit board and a plurality of LEDs arranged in an array and disposed on the bar-shaped circuit board, and a distribution density of the low-reflective dots is higher in areas of the reflecting surface corresponding to positions of the LEDs than in other areas of the reflecting surface.

17. The scanner according to claim 14, wherein the LED light source comprises a bar-shaped circuit board and a plurality of LEDs arranged in an array and disposed on the bar-shaped circuit board, and the light homogenizer comprises at least one protrusion disposed on the reflecting surface and positioned at locations corresponding to positions of the LEDs.

18. The scanner according to claim 14, wherein the light homogenizer comprises a plurality of reflective bumps.

19. The scanner according to claim 18, wherein the LED light source comprises a bar-shaped circuit board and a plurality of LEDs arranged in an array and disposed on the bar-shaped circuit board, and a distribution density of the reflective bumps is higher in areas of the reflecting surface corresponding to positions of the LEDs than in other areas of the reflecting surface.
